(19) United States
(12) Patent Application Publication
(10) Pub. No.: US 2011/0005952 A1
(43) Pub. Date: Jan. 13, 2011

(54) STORAGE CONTAINER FOR PAINT ROLLER COVERS

(76) Inventor: MICHAEL FENN, TORRINGTON, CT (US)

Correspondence Address: MCCORMICK, PAULDING & HUBER LLP, CITY PLACE II, 185 ASYLUM STREET, HARTFORD, CT, 06103, US

(21) Appl. No.: 12/832,446

(22) Filed: Jul. 8, 2010

Related U.S. Application Data
(60) Provisional application No. 61/223,833, filed on Jul. 8, 2009.

(51) Int. Cl. B44D 3/00

(52) U.S. Cl. 206/361

(57) ABSTRACT

The invention discloses a storage container for a roller cover usable in conjunction with a roller frame for painting. It comprises a housing configured in a first state to receive the roller cover within a cavity. In a second state, the housing allows a movement of the roller frame to and from the housing, but disallows a similar movement of the roller cover. A lid is configurable to close the housing. The housing may be configured to define at least in the second state, an opening operatively associated with the cavity. The opening is sized to allow insertion and removal of the roller frame there-through but to disallow insertion and removal of the roller cover there-through. The housing may have an open design in the first state, to allow for easy placement of the roller cover in the cavity. Various different configurations are described.

### CROSS-REFERENCE TO RELATED APPLICATIONS

This application claims the benefit of U.S. Provisional Application Ser. No. 61/223,833, filed on Jul. 8, 2009, which is herein incorporated by reference in its entirety.

### FIELD OF THE INVENTION

The invention is generally directed to mechanisms for storage of paint roller covers, and in particular to a storage container for paint roller covers.

### BACKGROUND OF THE INVENTION

During a standard workday a painter may use one or more roller covers. In some jobs, a painter may need to apply more than one coat of paint on a surface, and may use different roller covers for each coat painted (e.g. one roller cover for the primer, and one for the main color). In some jobs, a painter may need to paint different surfaces with different colors, and may use different roller covers for each of the surfaces (e.g. one roller cover for the primary color, and one for the accent color). In such and various other scenarios, there is a need for a storage container that allows for a roller cover to be removably stored, while another roller cover is being used. Storage containers may also be useful when a painter takes a break such as for lunch, or at the end of the day.

U.S. Pat. No. 5,074,098 describes a cylindrical container for storing a wet paint roller comprising a cylindrical sleeve and two end caps for closing the sleeve. The sleeve at one end has a short slot extending axially and a cooperating slot in the end cap aligned with the slot on the sleeve. The wet paint roller and the handle are both inserted into the container with the handle portion that extends from the axial rod passing through the slots in the sleeve and the end cap, thus containing the paint covered part within the container and the handle exposed outside. However, as the wet paint roller and the handle portion are held within the container during storage, an additional handle will be needed if a painter wishes to paint another surface with a different paint roller.

U.S. Patent Publication No. 2007/0295626 describes a storage container for a paint roller cover which includes a flexible, resilient tubular housing and a cap which can be snap-fitted thereon for removably storing the roller cover therein. The housing terminates in a built-in funnel for ease of insertion of the roller cover. The sides of the tubular housing include at least one section that is easily collapsible inwardly and can be pressed against the stored roller cover when the user grasps the housing. This collapsible section has teeth-like projections, which allow the user to engage and hold the roller cover in such a way that it can be pulled free from the roller frame without hand contact. This approach uses relatively complex design components; e.g. collapsible section, teeth-like projections, funnel. Additionally, the insertion of the roller cover into the housing can result in dripping of the wet paint along the sides of the housing.

Accordingly, there is a need for simple designs that allow for storage of a roller cover, without requiring direct handling of the roller cover by the painter's hand, gloved or otherwise, or resulting in dripping of any paint from the roller cover.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a storage container for paint roller covers.

In one aspect of the invention, there is provided a storage container for a roller cover usable in conjunction with a roller frame for painting. The storage container comprises a housing defining a cavity there within, and configured in a first state to allow the roller cover to be placed within the cavity. The housing is configured in a second state to allow a movement of the roller frame to and from the housing, but to disallow a movement of the roller cover to and from the housing. The storage container further comprises a lid configurable to close the housing.

In one aspect of the invention, there is provided a storage container for a roller cover usable in conjunction with a roller frame for painting. The storage container comprises a housing configured in a first state to receive the roller cover in a cavity defined within the housing. The housing is further configured at least in a second state to define an opening operatively associated with the cavity. The opening is sized to allow for insertion and removal of the roller frame there-through but to disallow insertion and removal of the roller cover there-through. The storage container further comprises a lid operatively associated with the housing and configurable to close the opening.

In another aspect of the invention, there is provided a storage container for a roller cover usable in conjunction with a roller frame for painting. The storage container comprises a housing comprising two operatively associated housing portions. At least one of the portions is configured in an open state of the housing to receive the roller cover in a cavity defined by the portion. The portions allow closing of the housing to a closed state wherein the housing is configured to define an opening operatively associated with the cavity. The opening is sized to allow for insertion and removal of the roller frame there-through but to disallow insertion and removal of the roller cover there-through. The storage container further comprises a lid operatively associated with the housing and configurable to close the opening.

### BRIEF DESCRIPTION OF THE DRAWINGS

Embodiments of the present invention will now be described, by way of example only, with reference to the attached Figures.

FIG. 1 is a perspective view of a storage container in a first state, in accordance with an embodiment of the invention, and comprising a housing and a separate cover plate.

FIG. 2 is a perspective view of the storage container of FIG. 1 in a second state, and containing a roller cover there-within.

FIG. 3 is a perspective view of a storage container in an open and empty state, in accordance with one embodiment of the invention.

FIG. 4 is a perspective view of the storage container of FIG. 3, in an open state and containing the roller cover at least partially mounted on the roller frame.

FIG. 5 is a perspective view of the storage container of FIG. 3, in a closed state with the roller frame being removed from the storage container while retaining the roller cover within the storage container.

FIG. 6 is a perspective view of the storage container of FIG. 3, with the roller frame completely removed and the roller cover retained within the storage container closed with a lid.

FIG. 7 is a partial cross-sectional side view of FIG. 6.

FIG. 8 is an end view of the storage container of FIG. 3, in an open state containing the roller cover such as in FIG. 4.

FIG. 9 is a perspective view of a storage container in accordance with another embodiment of the invention. The storage container comprises a housing and a cover plate hinged thereto.

FIGS. 10 and 11 show perspective views of a storage container in the first and second states respectively, in accordance with yet another embodiment of the invention.

FIGS. 12 and 15 show perspective views of a storage container in a first open state and a second closed state respectively, in accordance with another embodiment of the invention. The storage container comprises a housing and a cover plate sliding relative thereto. FIGS. 13 and 14 show cross-sectional side views of the storage container in a partially closed state and the second (fully) closed state (corresponding to FIG. 12) respectively.

### DETAILED DESCRIPTION OF THE INVENTION

Unless defined otherwise, all technical and scientific terms used herein have the same meaning as commonly understood by one of ordinary skill in the art to which this invention belongs.

The invention discloses a storage container for paint roller covers that can be mounted on roller frames for painting. The storage container comprises a housing defining a cavity there-within. The housing is configured in a first state to allow the roller cover to be received within the cavity. The housing is further configured in a second state to allow a movement of the roller frame to and from the housing, but to disallow a movement of the roller cover to and from the housing. The storage container further comprises a lid operatively associated with the housing and configurable to close the housing.

In embodiments of the invention, the housing allows for easy placement of the roller cover in the cavity defined within the housing, aided in part by the openness of the housing in the first state. The openness is achieved for example, using a separate cover plate as shown in FIG. 1 or a hinged design as shown in FIG. 3. To allow for the movement of the roller frame to and from the housing while preventing such movement of the roller cover, the housing may be partly flexible, in accordance with embodiments of the invention. The flexible portions of the housing allow collapse of the housing at least in the second state, by application of a force. The housing may thus be collapsed to a size that allows for to and fro movement of the roller frame, but not of the roller cover.

In embodiments of the invention, the housing is configured in the second state to define an opening operatively associated with the cavity. The opening is sized to allow for insertion and removal of the roller frame there-through but to disallow insertion and removal of the roller cover there-through. The lid operatively associated with the housing is configurable to close the opening.

FIGS. 1 and 2 show perspective views of a storage container 100, in accordance with an embodiment of the invention. The housing 110 defines there-within a cavity 120 operatively associated with an opening 130. The opening 130 is large enough to allow the insertion and removal of the roller frame 160 there-through, but is too small to allow insertion or removal of a roller cover 150 there-through.

Referring to FIG. 1, in a first state of the housing 110, the roller cover 150 can be placed within the cavity 120 of the housing 110. If placing a roller cover 150 while mounted on a roller frame 160 within the cavity 120, the opening 130 is designed to allow the handle portion of the roller frame 160 to extend outside the housing 110. The housing may be closed using a cover plate 140. FIG. 1 shows the roller frame 160 partially removed through the opening 130 from the housing 110. Alternately, the roller frame 160 may be removed from the housing 110 after its closing using the cover plate 140.

Referring to FIG. 2, the housing 110 is closed using the cover plate 140. The roller frame 160 has been pulled away and removed from the housing 110 through the opening 130. As the opening 130 is smaller than the diameter of the roller cover 150, the roller cover 150 is retained within the cavity 120 of the housing 110, as shown in FIG. 2. The removed roller frame 160 can be used by the painter for the other jobs. Thus, a roller cover 150 can be removed from a roller frame 160 without its direct contact with a painter's hand or body.

A lid 170 may be operatively associated with the housing 110 allowing for closing of the opening 130 to ensure that a roller cover 150 contained within the housing 110 does not dry out due to air contact. The lid 170 may therefore be shaped to substantially conform to the shape of the opening 130, to create a substantially air-tight storage container 100, which will preserve the roller cover 150, for ready re-use.

For re-use of the roller cover 150, the lid 170 is opened, to allow insertion of roller frame 160 through the opening 130 of the storage container 100. After the roller frame 160 is fully inserted to engage the roller cover 150 within the housing 110, the cover plate 140 can be removed and the roller frame 160 with the roller cover 150 mounted thereon can be removed for use in painting. Thus, the roller cover 150 can be both stored and removed for re-use without any direct contact of the roller cover 150 with the painter's body or hands.

The external walls of the housing 110 may be of different shapes, including but not limited to the shape of FIG. 1, or the shapes shown in other figures. The cavity 120 defined within the housing 110 may be of different shapes including but not limited to the semi-cylindrical shape of FIG. 1.

The cavity 120 may be appropriately sized to ensure minimal rattling of the roller cover 150 when stored within the storage container 100. A worker skilled in the art would also readily appreciate that the storage container 100 can be readily modified to accommodate different nap diameters/thicknesses, such as by variation of the sizes of the cavity 120 and the opening 130 of the housing 110.

For the embodiment of FIGS. 1 & 2, the cover plate 140 is separate from the housing 110 and frictionally engages the housing 110 in its closed state of FIG. 2. In other embodiments, the cover plate may be attached to the housing by a hinge mechanism. Other mechanisms for attachment of a cover plate to the housing would be readily known to a worker skilled in the art.

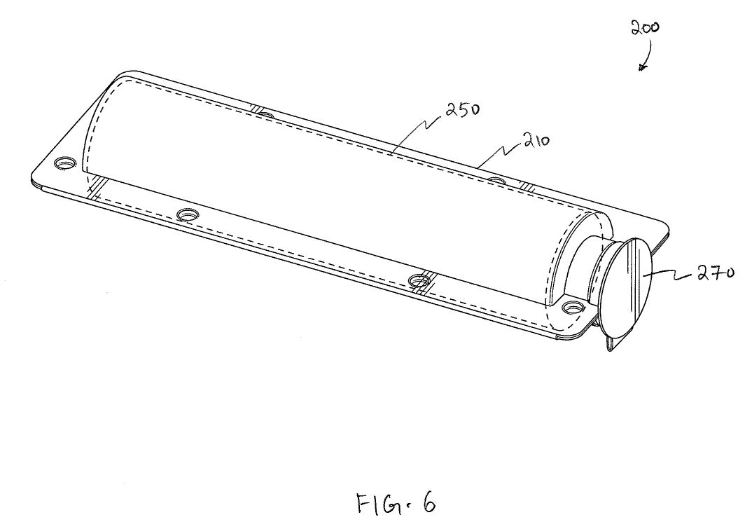

FIGS. 3 to 8 show an embodiment utilizing a clam-shell-type design wherein the housing 210 comprises two complementary portions 212, 216 joined by a hinged edge 211. The portions 212, 216 each comprise a first cavity 222, 226 and a contiguous second cavity 232, 236. When the housing 210 is closed, the first cavities 222, 226 combine to form a cavity 220 that houses the roller cover 250 therein; and the second cavities 232, 236 combine to form a second cavity terminating in an opening 230, which allows for movement of the roller frame 260 there-through, but prevents the movement of the roller cover 250 there-through. Thus, the two portions 212, 216 of the housing 210 in unison provide the same functionality as the housing 110 and cover plate 140 of FIG. 1. A worker skilled in the art would readily appreciate that the open state of the housing 210, as shown for example in FIG. 3 allows for easy placement of the roller cover within either of the first cavities 222, 226.

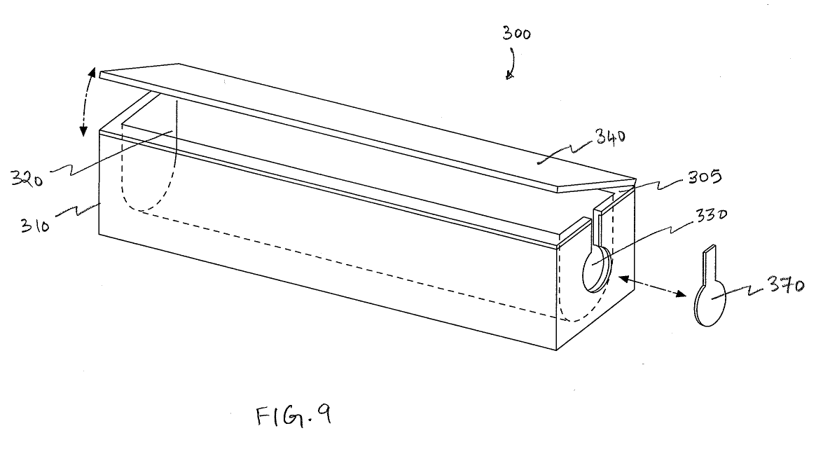

Referring to FIG. 9 and in accordance with an embodiment 300, a cover plate 340 is hinged to a housing 310 and allows for closing and opening of the housing 310. The cavity 320 defined within the housing 310 is used to receive a roller cover (not shown) in a first (open) state of the housing 310. The opening 330 allows for removal of a roller frame there-through but prevents the removal of the roller cover there-through. Various hinged mechanisms would be readily known to a worker skilled in the art.

As noted previously, the external walls of the housing and the cavity for receiving the roller cover may be of different shapes. For the embodiment 300 of FIG. 9, the external walls of the housing 310 have the shape of a rectangular box, while the inner cavity 320 used to receive the roller cover is approximately semi-cylindrical, and is defined by an insert 305 placed within the housing. The insert 305 may be made of different materials. In one embodiment, the insert 305 is made of an absorbent material (e.g. a sponge-like material) that aids in absorption of any excess paint that drips from a wet roller cover placed within the cavity 320. A painter may choose to replace the insert 305 without replacing the housing 310.

A worker skilled in the art would appreciate that a single housing may comprise several spaced-apart openings on the side of the housing, allowing for storage of multiple roller covers and their re-use. Each of the plurality of roller covers stored within the housing may be stored in individual cavities created by a composite insert, or by multiple separate inserts similar to the insert 305 shown in FIG. 9. A single housing allowing for storage of multiple roller covers may be of particular interest to painters working in job sites using multiple colors.

As noted above, a lid is operatively associated with the housing and can be used to seal the opening and thus, create a substantially air-tight environment for the roller cover. The lid may be attached to the housing (see lid 270 attached to the housing portion 212 in FIG. 3), or to the cover plate (see lid 170 attached to cover plate 140 in FIGS. 1 & 2), or may be separate from both the housing and the cover plate (see lid 370 separate from the cover plate 340 and the housing 310 in FIG. 3).

Various means may be used to retain the housing of the storage container in a second state. For the embodiment 100 of FIGS. 1 & 2, the cover plate 140 closes the housing 110 frictionally. For the embodiment 200 of FIGS. 3 to 8, the snap on mechanism provided by complementary means 282, 286 ensure that the housing remains shut.

The housing may be at least partially translucent or transparent to allow for a painter to easily see if the storage container is empty or full. In one embodiment, the transparent housing allows the painter to see paint color that was previously used for the roller cover.

The housing may be made of a flexible, resilient plastic. Alternately, the housing may be made of a bio-degradable material (e.g. bamboo, wood). Other materials may also be used for the housing as would be readily known to a worker skilled in the art.

The inner walls of the cavity may be lined with a material that allows for easy cleaning of the paint that has dripped from wet roller covers placed within. Alternately, the entire housing may be made of a material that allows for cleaning. Appropriate methods of cleaning the storage container from dripped paint, including washing with water or appropriate solvents, would be readily known to a worker skilled in the art.

The cavity may additionally provide some space allowing for storage of excess paint that drips from the used roller cover.

### EXAMPLE 1

FIGS. 3 to 8 describe a clam-shell-type design of the storage container 200, in accordance with an embodiment of the invention.

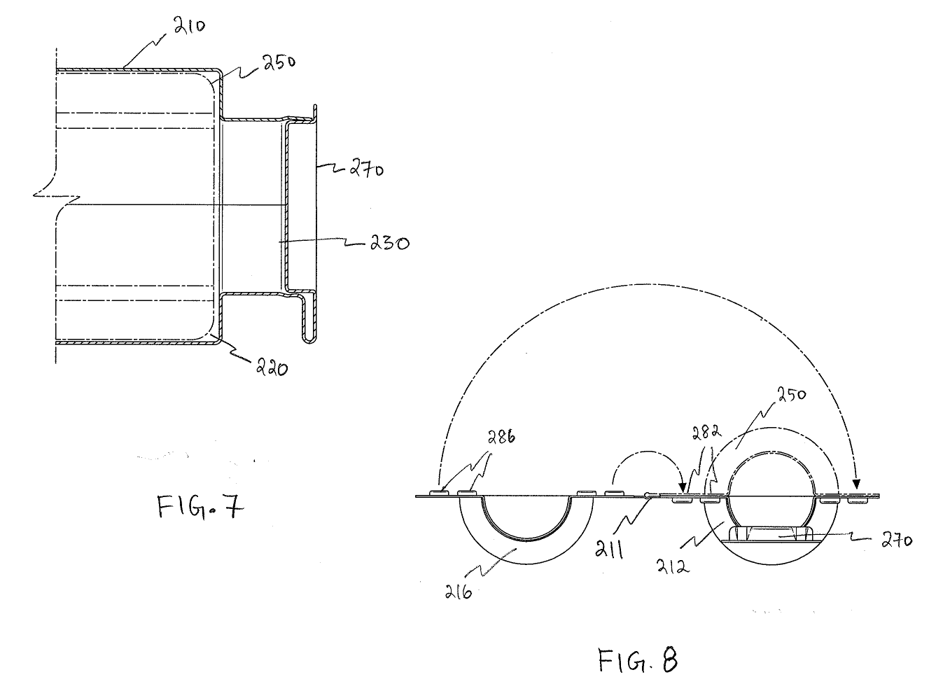

FIG. 3 shows a perspective view of the storage container 200 in a first (open) state, prior to receiving a roller cover 250. The housing 210 comprises two complementary portions 212, 216 each comprising a first semi-cylindrical cavity 222, 226 and a contiguous second semi-cylindrical cavity 232, 236. Referring also to FIG. 8, the complementary portions 212, 216 are joined together by a common hinged edge 211, which allow for the housing 210 to be opened and closed.

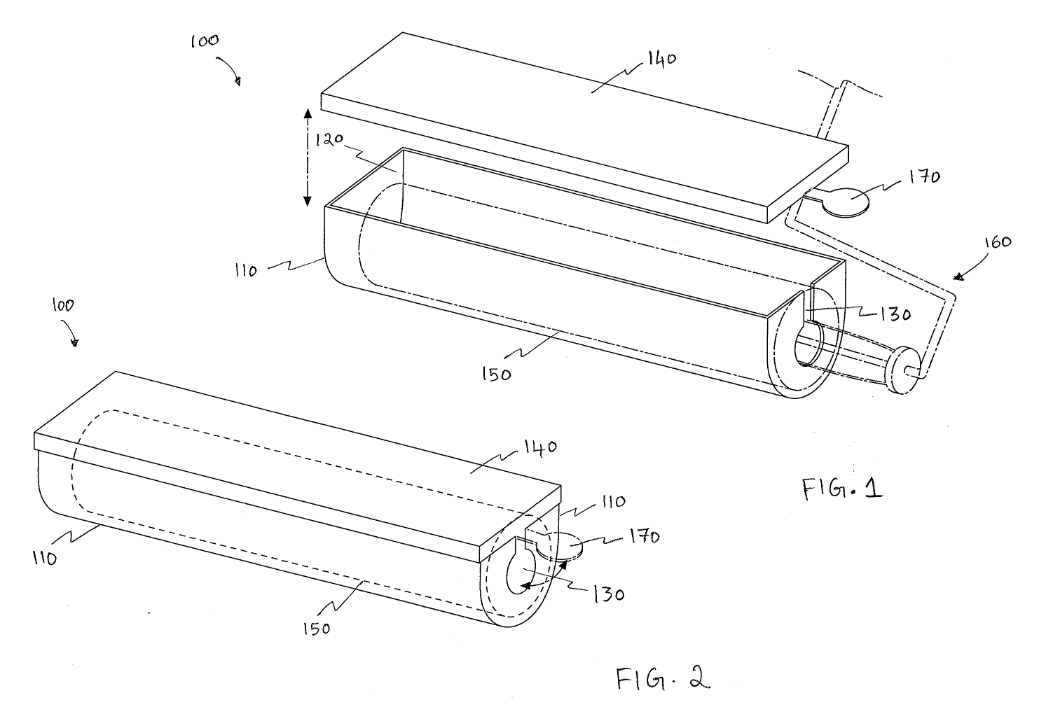

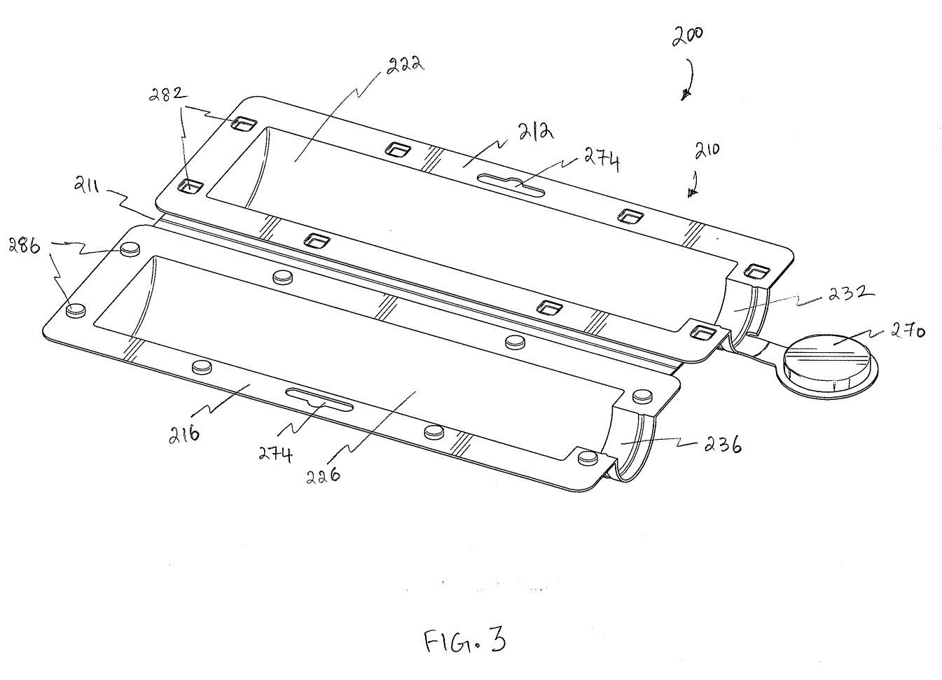

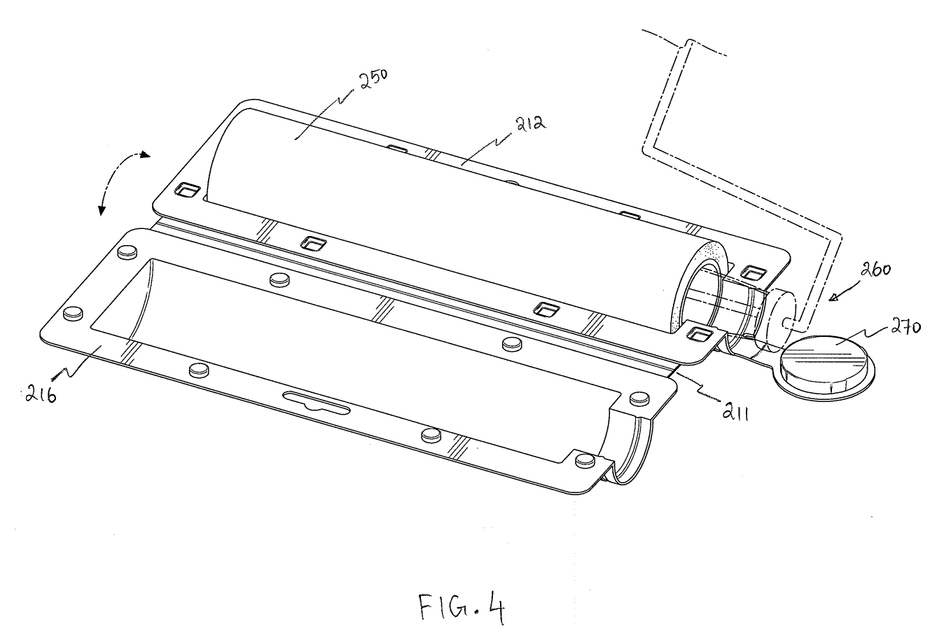

The open state of the storage container 200 allows for easy placement of the roller cover 250 inside the first semi-cylindrical cavity 222 of the portion 212, as shown in FIG. 4. A worker skilled in the art would readily appreciate that the roller cover 250 may just as well be placed in the first semi-cylindrical cavity 226 of the portion 216. If the roller cover 250 is mounted on a roller frame 260 when placed within the first semi-cylindrical cavity 222, the handle portion of the roller frame 260 is configured to extend outside of the second cylindrical cavity 232 of the portion 212.

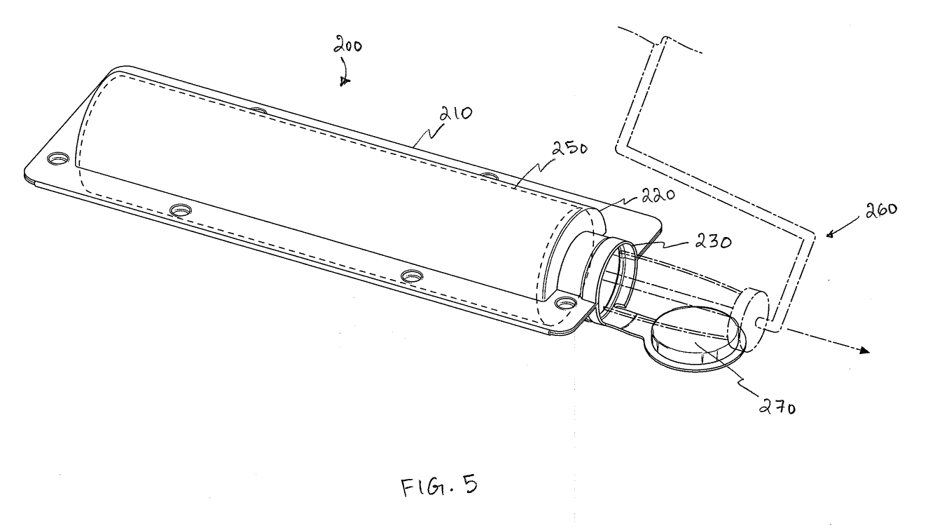

When the housing 210 is moved to a second (closed) state by operation of the hinged edge 211, first semi-cylindrical cavities 222, 226 combine to form the cylindrical cavity 220 which houses the roller cover 250 therein, while the second semi-cylindrical cavities 232, 236 form a second cylindrical cavity which terminates in the opening 230. The diameter of the opening 230 (and the second cylindrical cavity) is smaller than the diameter of the first cylindrical cavity 220, and is sized to allow insertion and removal of the roller frame 260 there-through while preventing the insertion or removal of the roller cover 250 there-through. FIG. 5 shows the housing 210 in a closed state, with the roller frame 260 partially removed there-from, while the roller cover 250 is restrained within the housing due to the smaller diameter of the opening 230.

Either one of the portions 212, 216 (portion 212 in FIGS. 3 to 8) has attached therewith a lid 270 shaped and sized to close the opening 230. The portions 212, 216 are further configured with complementary means 282, 286 that allow the portions 212, 216 to snap shut with respect to each other when closed. While FIG. 3 shows the complementary means 282, 286 as circular projections 282 fitting into square depressions 286, other shapes may also be used to allow snap-on as would be readily understood by a worker skilled in the art.

A worker skilled in the art would also readily understand that the length of the second semi-cylindrical cavities 232, 236 may be reduced without affecting the operation of the storage container 200. A longer semi-cylindrical region may however, provides space for collecting any dripped paint from a wet roller cover 250 placed within the storage container 200. The collected paint may be poured out by the painter prior to re-use of the stored roller cover 250.

For re-use of the roller cover 250, the lid 270 is opened, to allow insertion of roller frame 260 through the opening 230 of the storage container 200 in its closed state. After the roller frame 260 is fully inserted to engage the roller cover 250 within the housing 210, the housing 210 is opened and the roller frame 260 with the roller cover 250 mounted thereon can be removed for use in painting. Thus, the roller cover 250 can be both stored and removed for re-use without any direct contact of the roller cover 250 with the painter's body or hands.

Referring to FIG. 3, the complementary portions 212, 216 additionally provide means 274 allowing for easy portability of the storage container 200. For example, a hook or a ring may be passed through the means 274 for attachment to the painter's belt. Various means and modifications to the storage container 200 that allow for its easy portability would be readily known to a worker skilled in the art.

### EXAMPLE 2

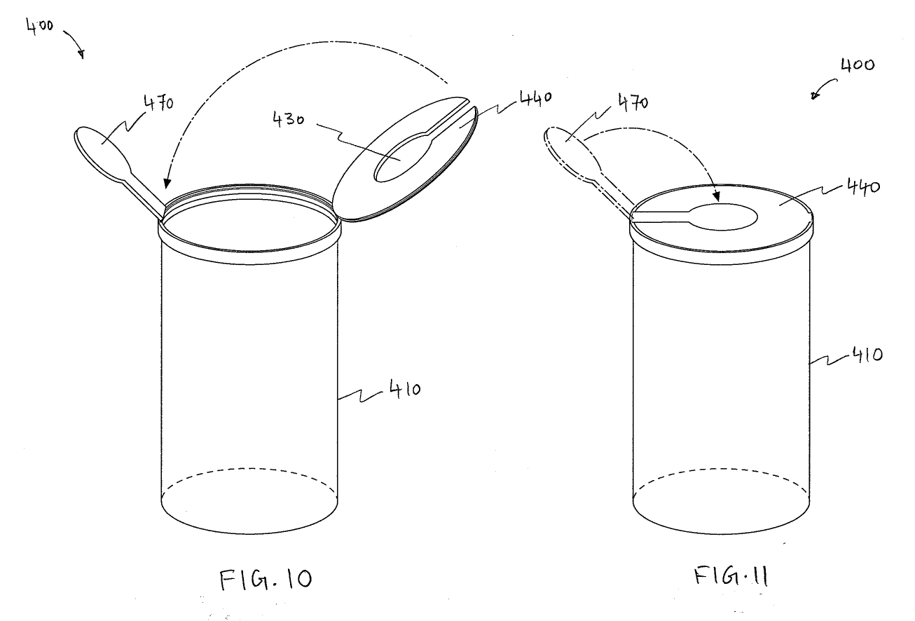

The example is directed to an embodiment 400 illustrated in FIGS. 10 and 11. FIG. 10 shows the first state of the housing 410 which allows for a roller cover (not shown) to be moved into the housing 410. The mouth of the housing 410 may be designed to allow for easy movement of the roller cover into the housing 410. In one embodiment, the mouth of the housing 410 may be funnel-shaped.

A cover plate 440 is then used to close the housing 410. The second (closed) state of the housing 410 is shown in FIG. 11. The cover plate 440 is designed to create an opening 430 for the housing 410. The opening 430 allows for removal of the roller frame there-through while preventing the removal of the larger roller cover there-through. A lid 470 can be used to close the opening 430 after the roller frame is removed from the housing 410. While both the cover plate 440 and the lid 470 are shown as hinged on the housing 410, other modifications would be readily known to a worker skilled in the art.

### EXAMPLE 3

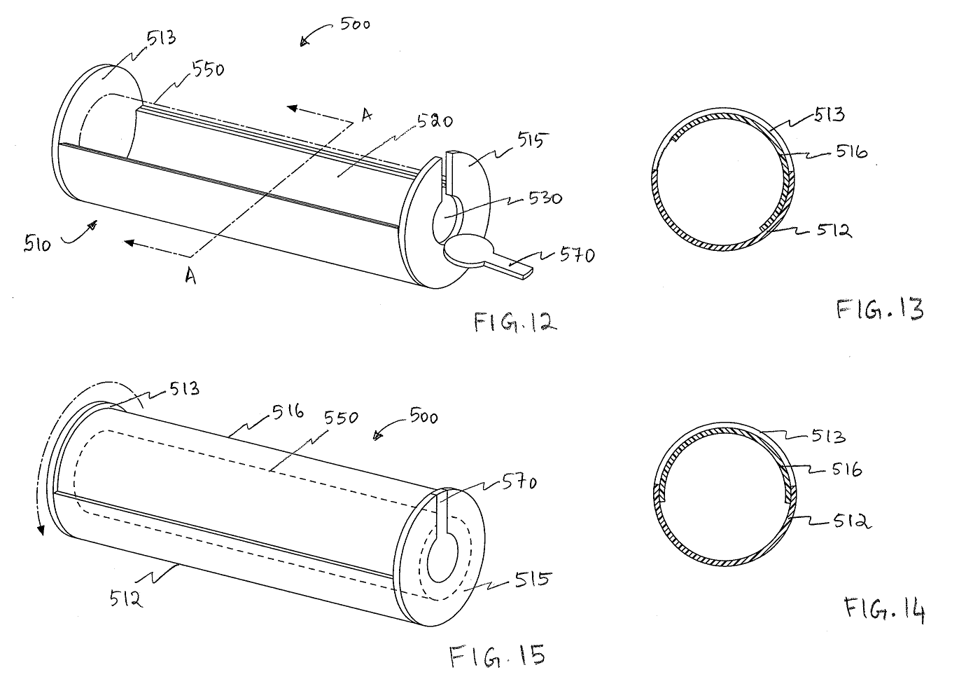

Referring to FIGS. 12 to 15, the example is directed to an embodiment of a storage container 500 comprising a housing 510 bounded by two end caps 513, 515 and defining a cavity 520 there-between. The end cap 515 defines an opening 530 that is sized to allow the movement of a roller frame there-through but to prevent a movement of a roller cover there-through. FIG. 10 shows a perspective view of a first state of the housing 510 prior to receiving a roller cover within the cavity 520.

The housing 510 comprises two portions 512, 516 free to slide relative to each other. The portion 516 is located within the portion 512 in the first state of the housing 510 shown in FIG. 12. In this state, the housing is open and allows for easy placement of the roller cover within the housing, with minimal dripping of any paint from the roller cover on the side of the housing.

The housing 510 can be fully closed to a second state by sliding the portion 516 relative to the portion 512. FIGS. 13 and 14 show the cross-sectional schematics of the storage container 500 (looking from plane A-A in FIG. 12) in a partially closed state, and the second (fully closed) state respectively.

FIG. 15 shows the perspective view of the storage container 500 with the housing 510 in its second (fully closed) state, corresponding to FIG. 14, and a lid 570 used to close the opening 530 after removal of the roller frame through the opening 530. The roller cover detached from the roller frame on account of the smaller size of the opening 530 is left in the cavity 520 of the storage container 500. The lid 570 is hinged to the end cap 515.

The invention being thus described, it will be apparent that the same may be varied in many ways. Such variations are not to be regarded as a departure from the spirit and scope of the invention, and all such modifications as would be apparent to a worker skilled in the art are intended to be included within the scope of the following claims.

What is claimed is:

1. A storage container for a roller cover usable in conjunction with a roller frame for painting, said storage container comprising:
a housing defining a cavity there within, and configured in a first state to allow said roller cover to be received within said cavity, and configured in a second state to allow a movement of said roller frame to and from said housing but to disallow a movement of said roller cover to and from said housing; and
a lid configurable to close said housing.

2. The storage container of claim 1, wherein the housing has an open position in said first state to allow for placement of the roller cover within said cavity.

3. A storage container for a roller cover usable in conjunction with a roller frame for painting, said storage container comprising:
a housing configured in a first state to receive said roller cover in a cavity defined within said housing, and configured at least in a second state to define an opening operatively associated with said cavity and sized to allow for insertion and removal of said roller frame there-through but to disallow insertion and removal of said roller cover there-through; and
a lid operatively associated with said housing and configurable to close said opening.

4. A storage container for a roller cover usable in conjunction with a roller frame for painting, said storage container comprising:
a housing comprising two operatively associated housing portions, at least one of said portions configured in an open state of said housing to receive said roller cover in a cavity defined within said portion, said portions allowing closing of said housing wherein said housing is configured to define, at least in said closed state, an opening operatively associated with said cavity and sized to allow for insertion and removal of said roller frame there-through but to disallow insertion and removal of said roller cover there-through; and
a lid operatively associated with said housing and configurable to close said opening.
